(19) United States
(12) Patent Application Publication
(10) Pub. No.: US 2016/0050210 A1
(43) Pub. Date: Feb. 18, 2016

(54) METHOD AND SYSTEM FOR MAINTAINING PRIVACY IN A MACHINE DIRECTED WORKFLOW FOR THE PURPOSE OF CREATING A SET OF AUTHORIZED USERS

(71) Applicant: Realtaasa, Inc., Cupertino, CA (US)

(72) Inventors: Christopher NGUYEN, Cupertino, CA (US); Tracy TRAN, Cupertino, CA (US)

(21) Appl. No.: 14/826,072

(22) Filed: Aug. 13, 2015

Related U.S. Application Data
(60) Provisional application No. 62/037,560, filed on Aug. 14, 2014.

(51) Int. Cl. H04L 29/06; G06F 17/30

(52) U.S. Cl. CPC H04L 63/101; G06F 17/30905

(57) ABSTRACT

Various of the disclosed embodiments concern methods and systems for maintaining privacy in a machine directed workflow for the purpose of creating a set of authorized users. According to one embodiment, the system maintains privacy by dividing information associated with a user into three privacy tiers. First privacy tier is configured to authorize access to all users. Second and third privacy tiers are configured to limit access to a subset of users. Once the system matches the users and receives authorization from the users, the system creates a set of authorized users, which can freely send messages to each other, and share first, second and third privacy tiers of information with each other.

### CROSS-REFERENCE TO RELATED APPLICATION

This application claims priority to the U.S. provisional patent application Ser. No. 62/037,560, filed Aug. 14, 2014, incorporated herein in its entirety and by this reference thereto.

### RELATED FIELD

Various embodiments relate generally to method and system for maintaining privacy in a machine directed workflow for the purpose of creating a set of authorized users.

### BACKGROUND

Traditionally, real estate databases, such as MLS, kept private information regarding the houses on sale and private information regarding the house owners available only to local real estate agents. However, today, online real estate companies, such as Zillow, take the private information from the MLS and make the information available on the Internet to the public, thus compromising the privacy of the seller and the seller's family. People with bad intentions could dig into public records to find out more about the seller's information, the house information and the financial details. In addition, foreign clients are making a large impact in the U.S. real estate. The problem the foreign and domestic clients face is the difficulty in creating a trusted team of local real estate professionals, and other parties, needed to complete the transaction, while still maintaining the parties' privacy.

In today's global economy going back to the secretive model of MLS is not practical. Instead, when a person is thinking of engaging in a real estate transaction and contacts a realtor (via telephone call, online via Zillow, etc.), the person is expected, and sometimes required, to first give out the person's contact information and exact property address, if the person is a seller, or the current address, if the person is a buyer. This disclosure of information compromises the person's privacy and safety.

### SUMMARY

Disclosed here is a secure system, providing an online platform for maintaining privacy in a machine directed workflow, that results in privacy protection and lower monetary cost to system users. The system users can be clients, such as buyers, sellers, co-owners, renters, or the users can be real estate professionals, and people or organizations, or both, who refer potential clients. The system provides a workflow for users to engage in real estate transactions, such as buying, selling, co-owning, or renting a real estate property, while maintaining the users' privacy. The property may be located inside the United States or internationally. Clients join for free. According to one embodiment, the real estate professional users join for free. In other embodiments, subscription fees may be collected from, or revenues shared with, the real estate professionals.

According to one embodiment, the system maintains privacy by dividing information associated with a first user into three privacy tiers. First privacy tier is configured to authorize access to all users associated with the system. Second and third privacy tiers are configured to limit access to a subset of users. Initially, the system displays the first privacy tier associated with the first user to a second user. The first user can choose to share second privacy tier with the second user, depending on how well the interests associated with the first user match the interests associated with the second user. Once the system matches the users and receives authorization from the users, the system creates a set of authorized users, which can freely send messages to each other, and share first, second and third privacy tier of information with each other.

According to another embodiment, the system maintains privacy by dividing information associated with a first user into two privacy tiers. The first privacy tier is configured to authorize access to all users associated with the system. The first privacy tier includes a sale price associated with a real estate property, and a description of the real estate property. If a user is interested in the real estate property, the system transmits a message containing the second privacy tier of information. Once the first user receives an offer, the system queries the first user to authorize transmission of the offer terms and the first user's comments regarding the offer terms. Once authorized, the system sends a message containing the offer terms to all the users that expressed an interest in the real estate property.

### BRIEF DESCRIPTION OF THE DRAWINGS

FIG. 1A is a diagram of the system according to various embodiments in the disclosure.

FIG. 1B is a flowchart of a method for maintaining privacy in a machine directed workflow, according to one embodiment.

FIG. 2 is a flowchart of a user registration process, according to one embodiment.

FIG. 3 is a flowchart of a registration process associated with a buyer, according to one embodiment.

FIG. 4 is a flowchart of a process for a buyer to get preapproved by a lender, according to one embodiment.

FIG. 5 is a flowchart of a process for matching co-owners, according to one embodiment.

FIG. 6 is a flowchart of registration process associated with a seller, according to one embodiment.

FIG. 7A is a flowchart of the traditional workflow associated with a seller, according to one embodiment.

FIG. 7B is a flowchart of the hybrid workflow associated with a seller, according to one embodiment.

FIG. 8 is a flow chart of a process for sharing and commenting on a real estate visual representation, according to one embodiment.

FIG. 9 is a flowchart of a process to determine the primary role associated with a user and one or more alternate roles, according to one embodiment.

FIGS. 10A, 10B, and 10C are an example of the legal questionnaire that a co-owner fills out, according to one embodiment.

FIGS. 11A-11I are an example of a personality questionnaire that a co-owner fills out, according to one embodiment.

FIG. 11J is an example of a user assigning weights to each questionnaire response, according to one embodiment.

FIG. 12A is an example of a display prompting a user to enter information regarding the desired property, according to one embodiment.

FIG. 12B is an example of the information a user can enter to describe the desired property, according to one embodiment.

FIG. 13 is a block diagram of a computer system as may be used to implement certain features of some of the embodiments.

### DETAILED DESCRIPTION

Various example embodiments will now be described. The following description provides certain specific details for a thorough understanding and enabling description of these examples. One skilled in the relevant technology will understand, however, that some of the disclosed embodiments may be practiced without many of these details.

Likewise, one skilled in the relevant technology will also understand that some of the embodiments may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this Detailed Description section.

### I. WORKFLOW FOR MAINTAINING PRIVACY

Disclosed here is a secure system, providing an online platform for maintaining privacy in a machine directed workflow, that results in privacy protection and lower monetary cost to system users. The system users can be clients, such as buyers, sellers, co-owners, or the users can be real estate professionals, and people or organizations, or both, who refer potential clients. The system provides a workflow for users to engage in real estate transactions, such as buying, selling, co-owning, or renting a real estate property, while maintaining the users' privacy. The property may be located inside the United States or internationally. Clients join for free. According to one embodiment, the real estate professional users join for free. In another embodiment, subscription fees may be collected from, or revenues shared with, the real estate professionals.

The system allows clients to find real estate professionals from any company who offer service in the local area where the property is located. The system network of real estate professionals can include a real estate professional from any country. The real estate professional users already have the means necessary to offer the service like their own licenses, offices, staff etc. The real estate professional users also have the experience needed. The system opens up the real estate professional market for fair competition by allowing the clients to communicate with real estate professionals before selecting one, without clients' having to reveal private information such as full name, property street address, contact information etc. However, the system protects clients, such as buyers, sellers or renters, from solicitation from real estate professional users. According to one embodiment, the real estate professional users cannot initiate conversations with the client users, instead the client user initiates the conversation with a real estate professional user via the system messaging.

The system network of clients includes buyers and sellers from any country. The real estate transactions in the system can be initiated online with no geographic limitation and completed with local real estate professional users where the property is located. In addition, the system can verify the identity of the user by verifying IDs and documents associated with the user. The system can utilize third-party applications such as NetVerify to verify users.

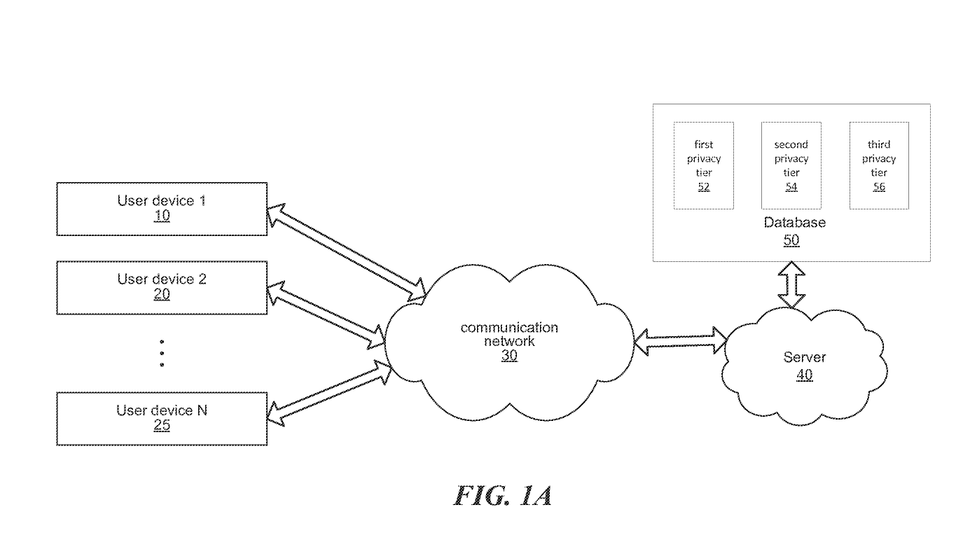

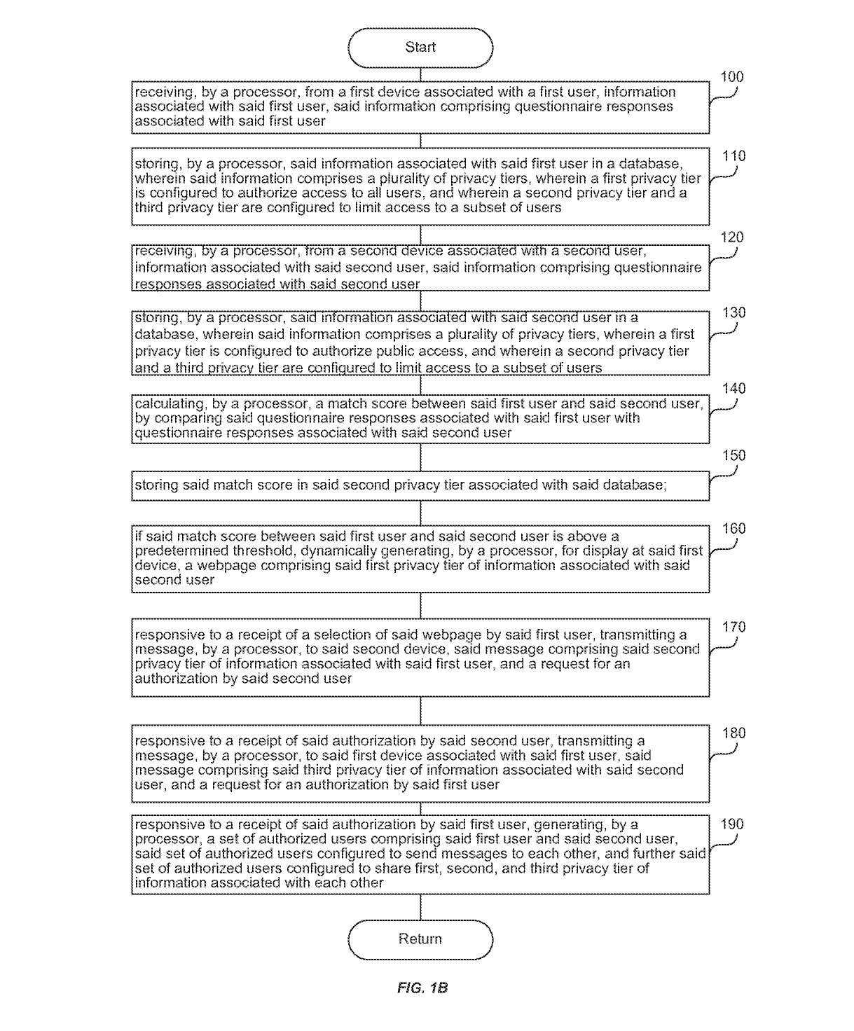

FIG. 1A is a diagram of the system according to various embodiments in the disclosure. A plurality of user devices 10, 20, 25 connect to the server 40, via a communication network 30. The server 40 stores the information it receives from the user devices 10, 20, 25 into the database 50, and divides the information into a plurality of privacy tiers 52, 54, 56. The user devices 10, 20, 25 and the server 40, communicate with each other and other components of the communication network 30 using well known, new, or still developing protocols. In this context, a protocol includes a set of rules defining how the network nodes within the communication network 30 interact with each other based on information sent over the communication links.

By way of example, the communication network 30 includes one or more networks such as a data network, a wireless network, a telephony network, or any combination thereof. The data network may be any local area network (LAN), metropolitan area network (MAN), wide area network (WAN), a public data network (e.g., the Internet), short range wireless network, or any other suitable packet-switched network, such as a commercially owned, proprietary packet-switched network (e.g., a proprietary cable or fiber-optic network, and the like, or any combination thereof). In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The user devices 10, 20, 25 are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, the accessories and peripherals of these devices, or any combination thereof.

FIG. 1B is a flowchart of a method for maintaining privacy in a machine directed workflow, according to one embodiment. In step 100, the server 40 receives, from a first user device associated with a first user, information associated with said first user, said information comprising questionnaire responses associated with said first user. In step 110, the server stores said information associated with said first user in a database 50, wherein said information comprises a plurality of privacy tiers, wherein a first privacy tier 52 is configured to authorize access all users associated with the system, and wherein a second privacy tier 54 and a third privacy tier 56 are configured to limit access to a subset of users.

According to one embodiment, the first privacy tier of information 52 comprises the visual representation associated with the first user, the prequalified dollar amount approved by a lender, and first name associated with the first user. The second privacy tier 54 comprises information regarding the desired property such as city, state, ZIP code, number of bedrooms, number of bathrooms, type of property, price range, visual representation associated with the property that the user is interested in etc. The visual representation can be a picture, a video, a virtual tour, a 3-D computer model, or any visual representation that can be displayed. The third privacy tier of information 56 comprises questionnaire answers associated with the first user.

According to one embodiment, the server 40 calculates the match score by matching at least a predetermined percentage of questionnaire responses associated with the first co-owner to questionnaire responses associated with the second co-owner. In one embodiment, the predetermined percentage is 50%. According to another embodiment, the server 40 calculates the match score by assigning weights to each questionnaire response, and generating a match score by adding weights of matching questionnaire responses. The weights can be generated automatically, or can be specified by the user. If generated automatically, according to one embodiment, each questionnaire response is given equal weight.

In step 120, the server 40 receives, from a second user device associated with a second user, information associated with said second user, said information comprising questionnaire responses associated with said second user. In step 130, the server 40 stores said information associated with said second user in a database 50, wherein said information comprises a plurality of privacy tiers, wherein a first privacy tier 52 is configured to authorize access to all users associated with the system, and wherein a second privacy tier 54 and a third privacy tier 56 are configured to limit access to a subset of users. A fourth privacy tier is configured to limit access to the administrators associated with the server 40. Fourth privacy tier of information comprises phone number associated with a user, the server 40 reference number, real estate property status (such as still on the market, sold, sale pending, canceled etc.), start selling date, cancellation date, or close of escrow date.

In step 140, the server 40 calculates, by a processor, a match score between said first user and said second user, by comparing said questionnaire responses associated with said first user with questionnaire responses associated with said second user. In step 150, the server 40 stores said match score in said second privacy tier 54 associated with said database 50. According to one embodiment, the server 40 calculates the match score by matching at least a predetermined percentage of questionnaire responses associated with the first co-owner to questionnaire responses associated with the second co-owner. In one embodiment, the predetermined percentage is 50% or more. According to another embodiment, the server 40 calculates the match score by assigning weights to each questionnaire response, and generating a match score by adding weights of matching questionnaire responses. The weights can be generated automatically, or can be specified by the user. If generated automatically, according to one embodiment, each questionnaire response is given equal weight.

In step 160, if said match score between said first user and said second user is above a predetermined threshold, the server 40 dynamically generates, by a processor, for display at the first device associated with said first user, a webpage comprising said first privacy tier of information 52 associated with said second user.

In step 170, responsive to a receipt of a selection of said webpage by said first device associated with said first user, the server 40 transmits a message, by a processor, to said second device associated with said second user, said message comprising said second privacy tier of information 54 associated with said first user, and a request for an authorization by said second user.

In step 180, responsive to a receipt of said authorization by said second user, the server 40 transmits a message, by a processor, to said first client device associated with said first user, said message comprising said third privacy tier of information 56 associated with said second user, and a request for an authorization by said first user.

In step 190, responsive to a receipt of said authorization by said first user, the server 40 generates, by a processor, a set of authorized users comprising said first user and said second user, said set of authorized users configured to send messages to each other.

### II. WORKFLOW FOR INTERNATIONAL USERS

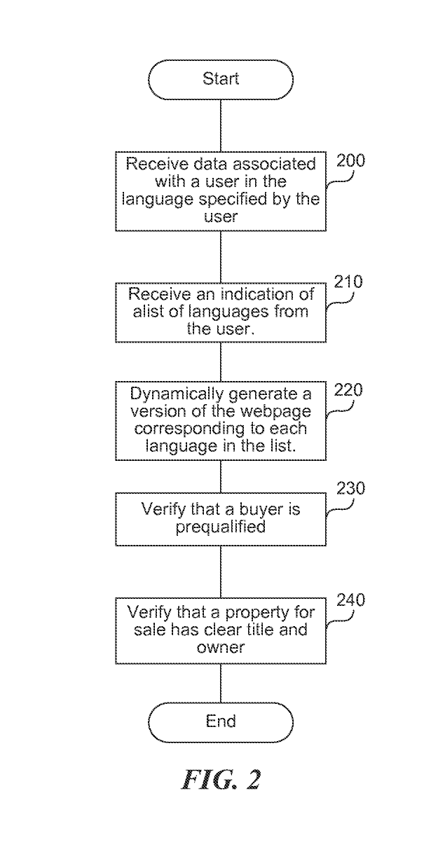

FIG. 2 is a flowchart of a user registration process, according to one embodiment. In step 200, the server 40 receives data associated with a user in a language specified by the user. In step 210, the server 40 receives an indication of a list of languages, such as the names of the languages, in which the user wants to create a profile. In step 220, the server 40 dynamically generates a version of the webpage corresponding to each language in the list of languages. The user can make changes to all webpages, and is responsible for the webpages' accuracy. In step 230, the server 40 verifies that a user who wants to buy a property is prequalified. In step 240, the server 40 verifies that property for sale has clear title and owner.

Users associated with the system, who are foreign buyers, can initiate most, and sometimes all, of the transaction work online with the system such as: getting prequalified by a lender; looking for a real estate agent and working with a real estate agent to find a property; even closing with an escrow company local to the area where the property is. The system requires less time, and less travel expenses because the buyer does not have to travel to the US to make the purchase.

### III. WORKFLOW FOR BUYERS

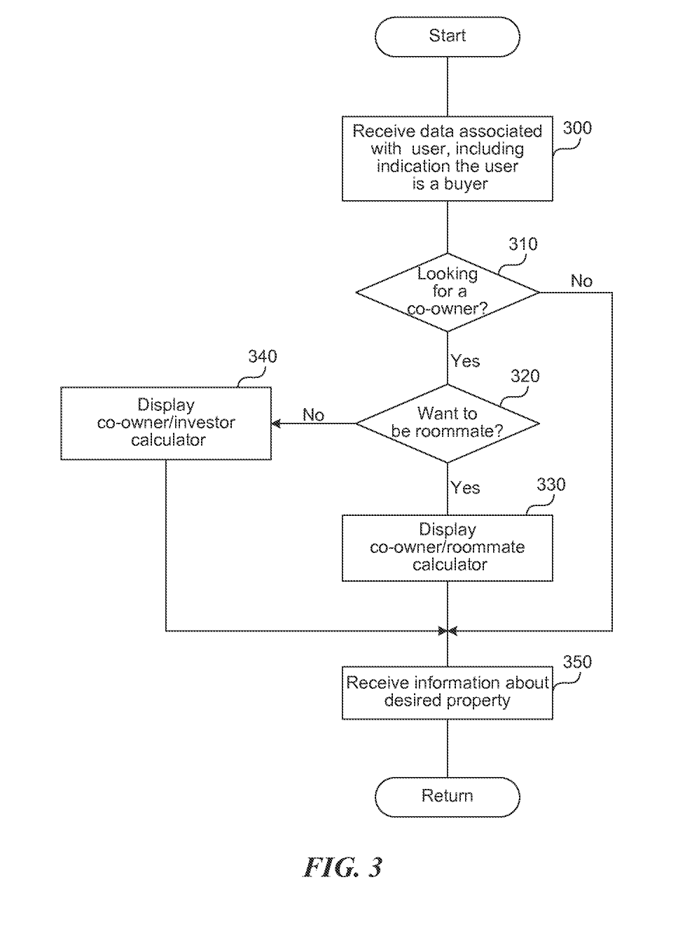

FIG. 3 is a flowchart of a registration process associated with a buyer, according to one embodiment. In step 300, the server 40 receives data associated with a user, including an indication that the user is a buyer. The received data comprises full name, visual representation associated with the buyer, phone number, ZIP code, link to social media such as LinkedIn or Facebook. The visual representation can be a picture, a video, a virtual tour, a 3-D computer model, or any visual representation that can be displayed. First privacy tier of information 52 comprises the visual representation, and first name associated with the buyer.

In step 310, the server 40 queries the user whether the user is looking for a co-owner. If the user is looking for a co-owner, in step 320, the server 40 queries the user whether the user wants to live at the property. If the user wants to live in the property, in step 330 the server 40 displays the co-owner/roommate calculator. The co-owner/roommate calculator queries the user about the number of desired co-owners, the desired house price, etc. to estimate personal share of down payment, monthly payment, and estimate tax savings.

If the user does not want to live at the property, in step 340, the server 40 displays the co-owner/investor calculator. The co-owner/investor calculator queries the user about how much a down payment the user wants to contribute, how much monthly mortgage payment the user wants to contribute, the total home price, and returns percent of return on investment, and monthly savings.

Finally, in step 350, the server 40 receives information regarding the desired property such as city, state, ZIP code, number of bedrooms, number of bathrooms, type of property, price range, visual representation associated with the property that the user is interested in etc. The visual representation can be a picture, a video, a virtual tour, a 3-D computer model, or any visual representation that can be displayed. The server 40 can receive any number of cities, states, ZIP codes, and the range of numbers for the number of bedrooms, and number of bathrooms. The information regarding desired property comprises information associated with second privacy tier 54, which can be shared with other users only when permitted by the buyer. The information regarding desired property is displayed on the private dashboard associated with a buyer.

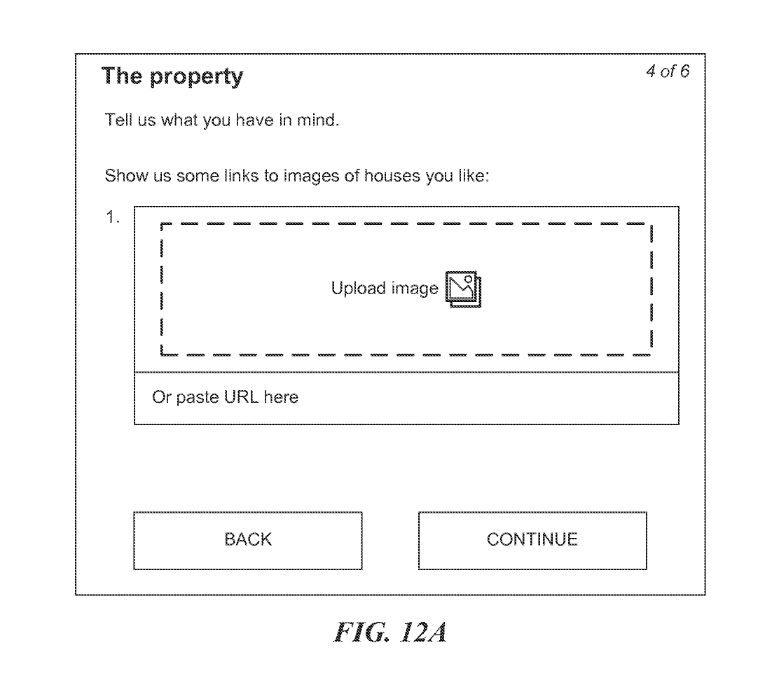

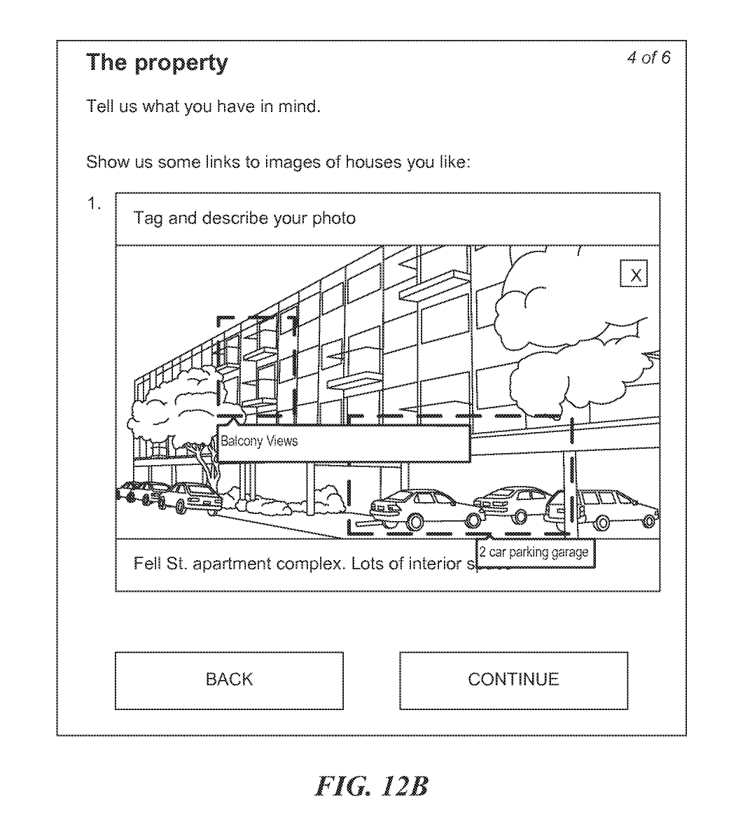

FIG. 12A is an example of a display prompting a user to enter information regarding the desired property, according to one embodiment.

FIG. 12B is an example of the information a user can enter to describe the desired property, according to one embodiment.

According to one embodiment, during the registration, the server 40 requires the buyer to agree to Terms of Service by accepting the system as a referral system, not as a real estate buyer agent. The server 40 asks the buyer to agree to pay the system referral fee if a buyer agent is not used. The server 40 requires the buyer to read and agree to disclaimers from the system.

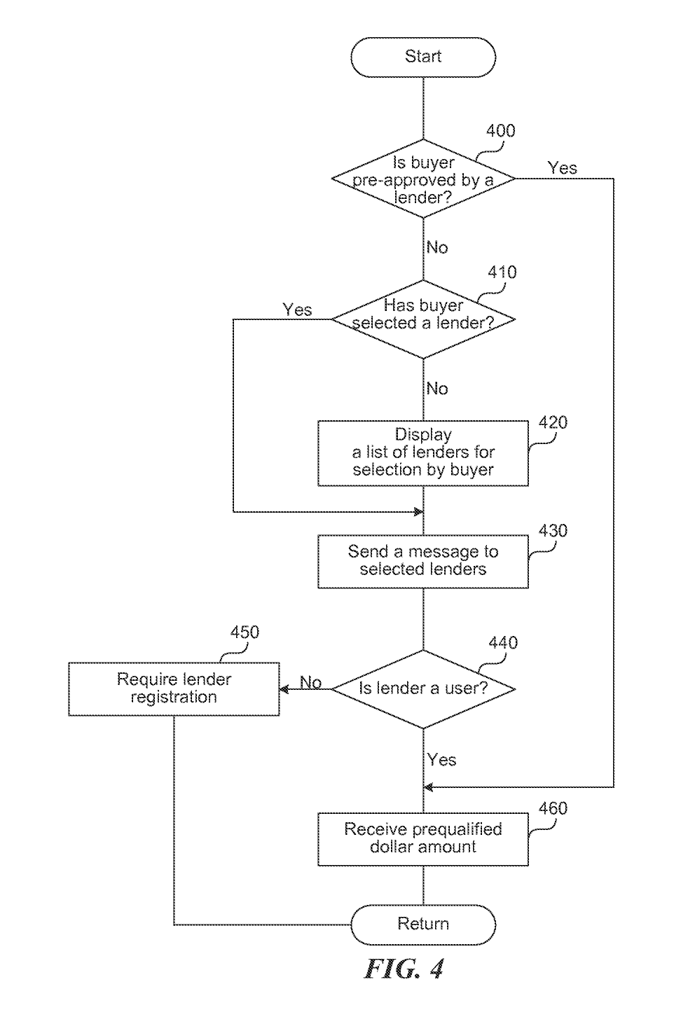

FIG. 4 is a flowchart of a process for a buyer to get preapproved by a lender, according to one embodiment. In step 400, the server 40 queries the buyer if the buyer is preapproved by a lender. If the buyer is preapproved by a lender the server 40 goes to step 460. If the buyer is not preapproved by a lender, in step 410, the server 40 queries the buyer if the buyer has selected a lender. If the buyer has selected a lender, the server 40 goes to step 430. In the buyer has not selected a lender, in step 420, the server 40 displays a list of lenders for selection by buyer. Once the buyer selects one or more lenders, in step 430, the server 40 sends a message to selected lenders to ask for a preapproval letter regarding the buyer. Once a lender preapproves the buyer, in step 440, the server 40 queries the lender if the lender is a user of the system. If the lender is not a user of the system, in step 450, the server 40 requires the lender to register. If a lender is a user of the system, in step 460, the server 40 asks the lender to input the dollar amount of the loan for which the buyer is prequalified. The prequalified dollar amount comprises information associated with the first privacy tier 52.

### Workflow for Matching Co-Owners

The server 40 requires the buyer who is a first co-owner to agree to terms that allows the server 40 to look for a second co-owner. The server 40 requires the first and the second co-owner, who were matched by the server 40, to agree to pay the system directly or have their agent pay the system a predefined referral fee when the buying transaction closes successfully.

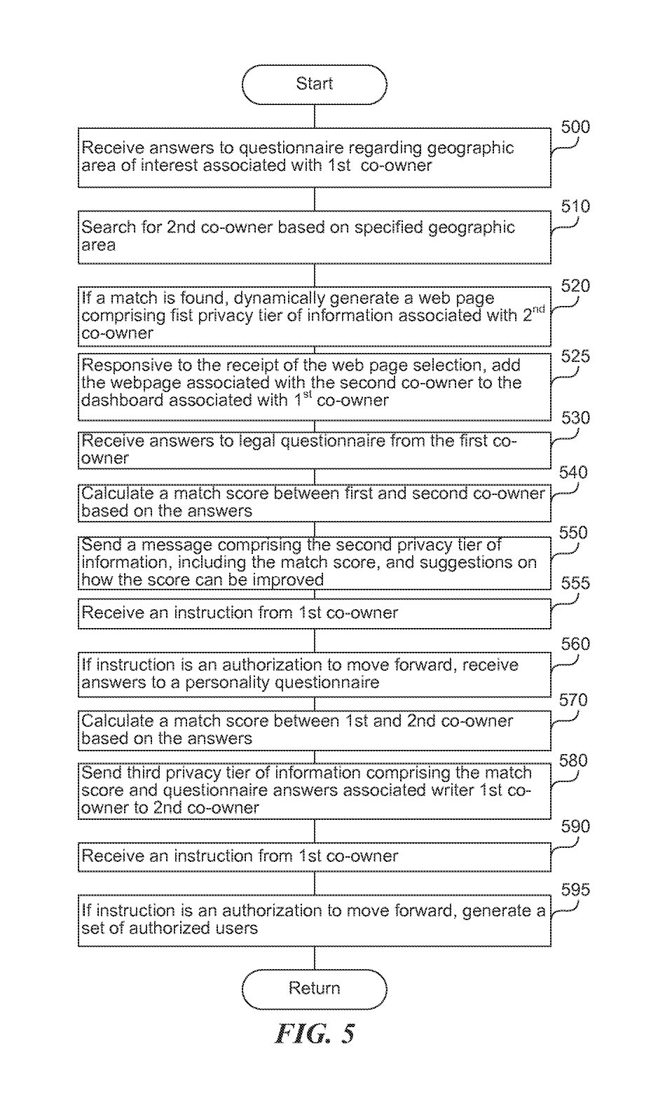

FIG. 5 is a flowchart of a process for matching co-owners, according to one embodiment. In step 500, the server 40 receives, from the first co-owner, answers to a questionnaire regarding the geographic area where the first co-owner is looking for real estate property. In step 510, based on the specified geographic area, the server 40 searches for a second co-owner until it either finds a match, or a specified event occurs, such as a predetermined number of days passes (for example, a month), or the server 40 has completed a predetermined number of searches (for example, 100).

In step 520, if a match is found, the server 40 dynamically generates a webpage comprising the first privacy tier of information 52 associated with a second co-owner, such as the visual representation associated with the second co-owner, first name, and dollar amount prequalified by lender. The visual representation can be a picture, a video, a virtual tour, a 3-D computer model, or any visual representation that can be displayed. In step 525, if the first co-owner selects the second co-owner, the server 40 adds the webpage associated with the second co-owner to the dashboard associated with the first co-owner.

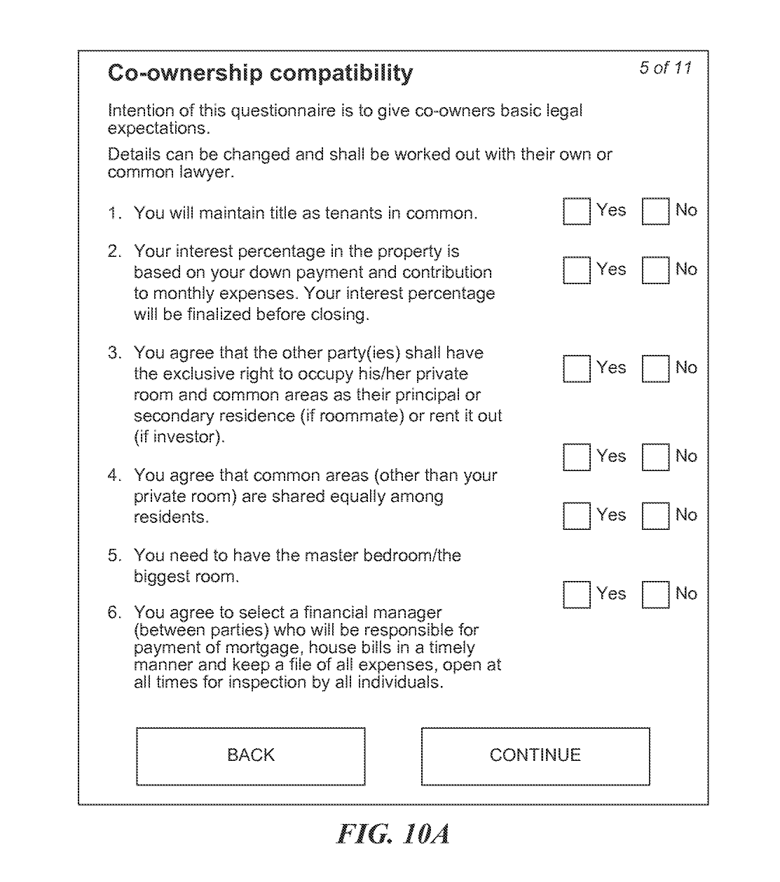

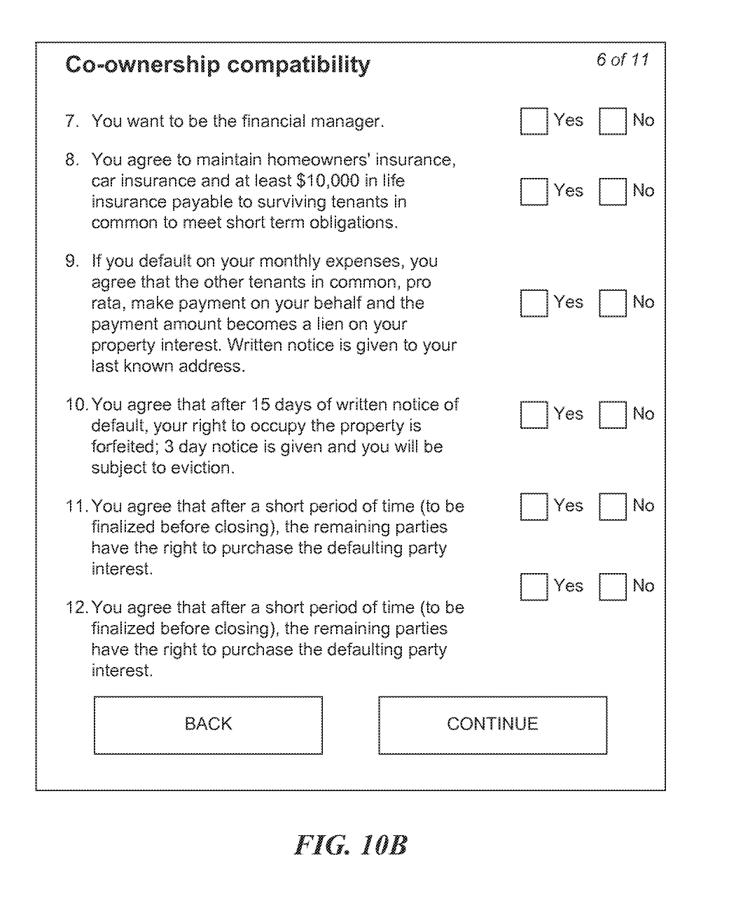

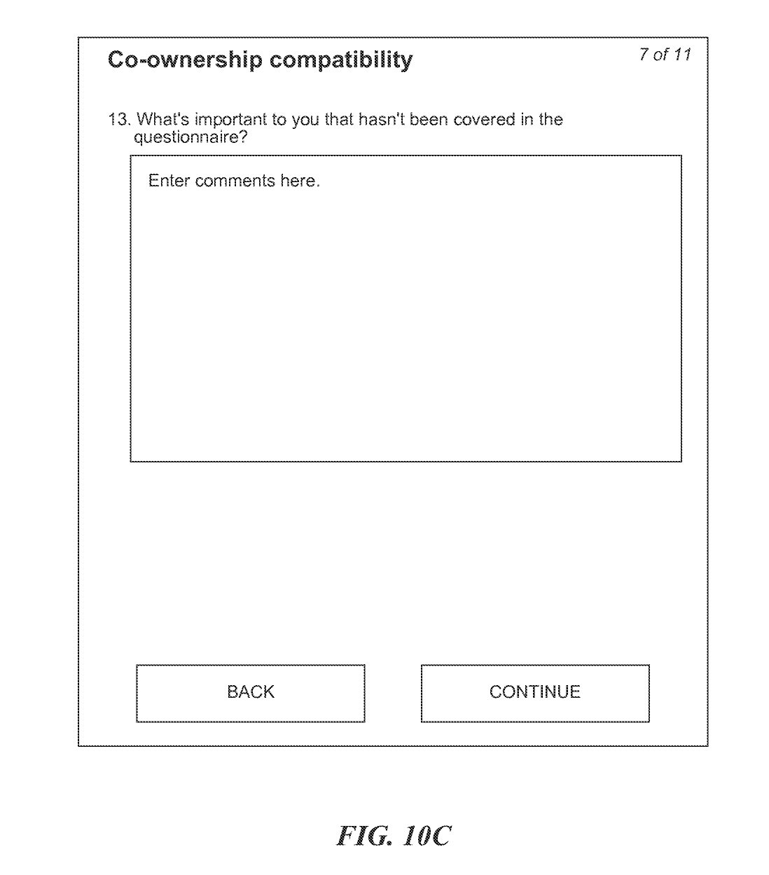

In step 530, the server 40 receives, from the first co-owner, answers to a legal questionnaire. The legal questionnaire comprises questions regarding whether the co-owner wants to be on the title, expectations associated with a co-owner regarding common areas and private areas, or expectations associated with a co-owner regarding insurance. FIGS. 10A, 10B, and 10C are an example of the legal questionnaire that a co-owner fills out, according to one embodiment.

In step 540, the server 40 calculates a match score between the first and the second co-owner, based on the answers to the legal questionnaire. According to one embodiment, the server 40 calculates the match score by matching at least a predetermined percentage of questionnaire responses associated with the first co-owner to questionnaire responses associated with the second co-owner. In one embodiment, the predetermined percentage is 50% or more. According to another embodiment, the server 40 calculates the match score by assigning weights to each questionnaire response, and generating a match score by adding weights of matching questionnaire responses. The weights can be generated automatically, or can be specified by the user. If generated automatically, according to one embodiment, each questionnaire response is given equal weight. In another embodiment, the server 40 proceeds to step 550 if the match score exceeds a predetermined threshold. In one embodiment, the predetermined threshold is 49% of total weight.

In step 550, the server 40 sends a message to the first co-owner comprising second privacy tier of information 54, which includes the match score, and suggestions on how the score can be improved. According to one embodiment, the second privacy tier of information 54 comprises the match score and the answers to the legal questionnaire associated with the second co-owner. In step 555, the server 40 receives an input from the first co-owner comprising an instruction to change the answers to the legal questionnaire to affect the score associated with the first co-owner, to delete the second co-owner from the dashboard associated with the first co-owner, or an authorization to move to step 560.

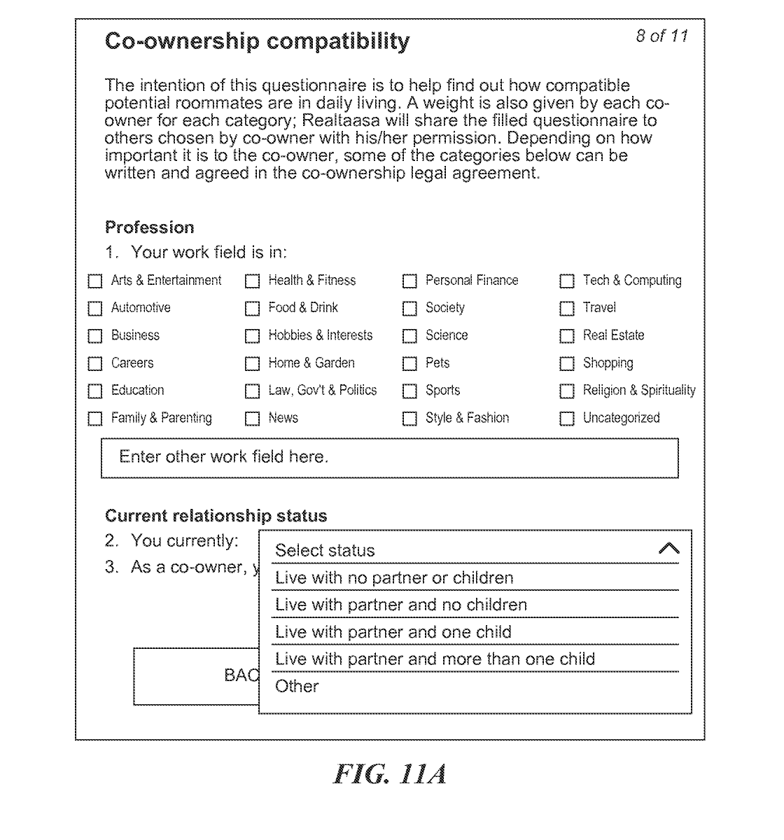

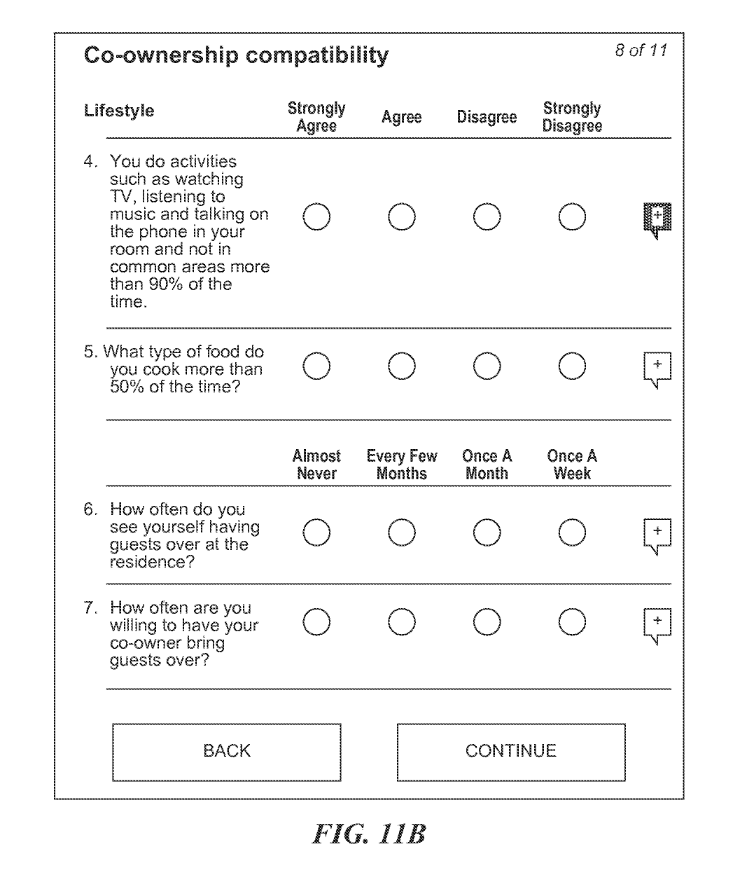

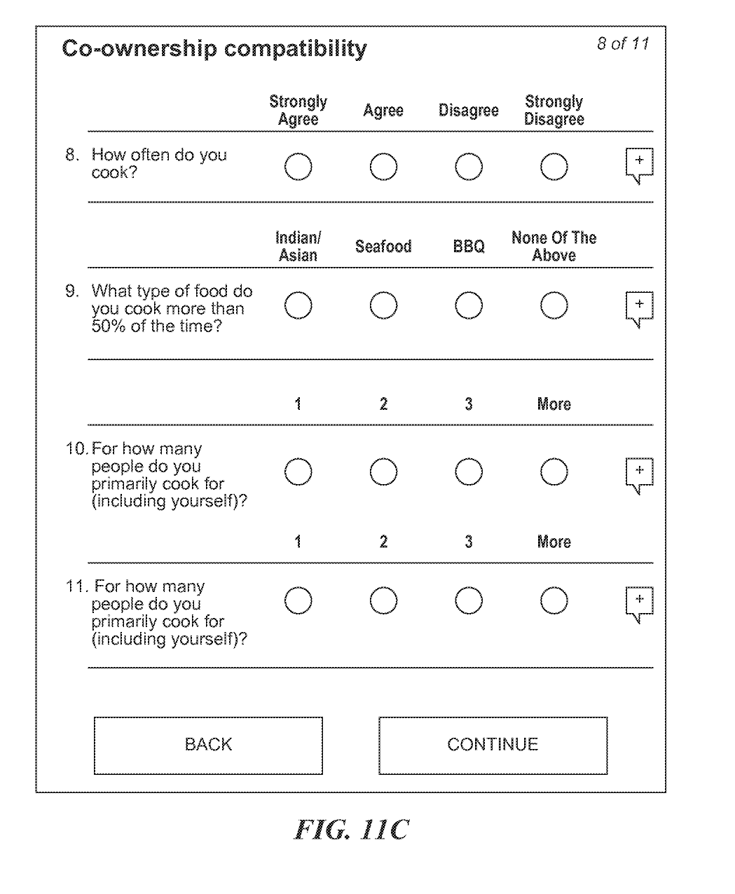

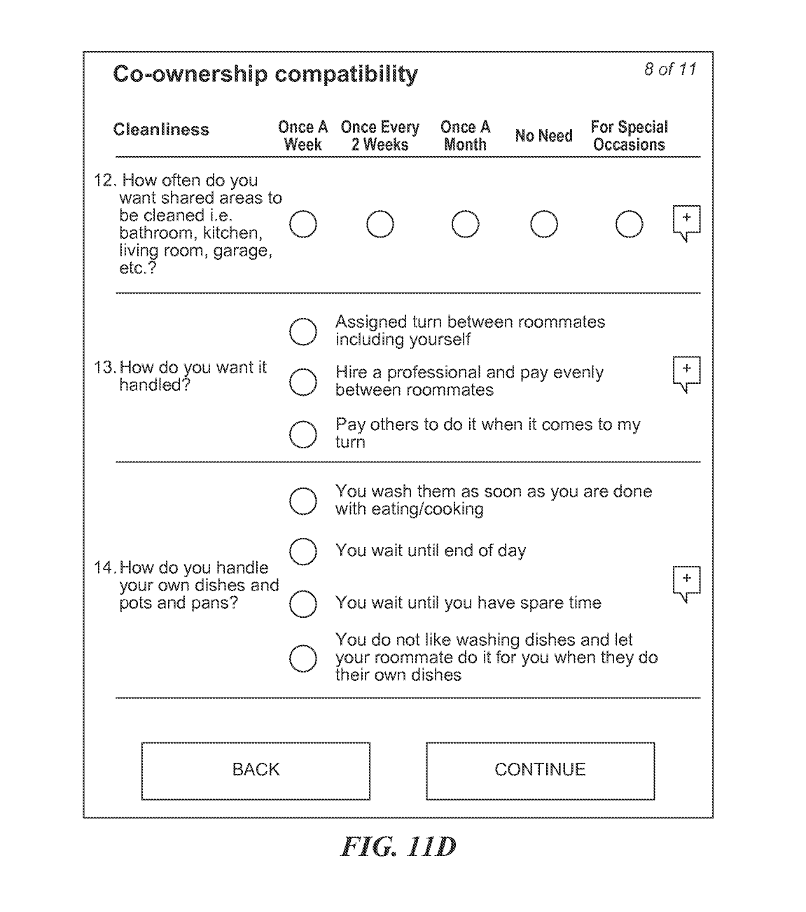

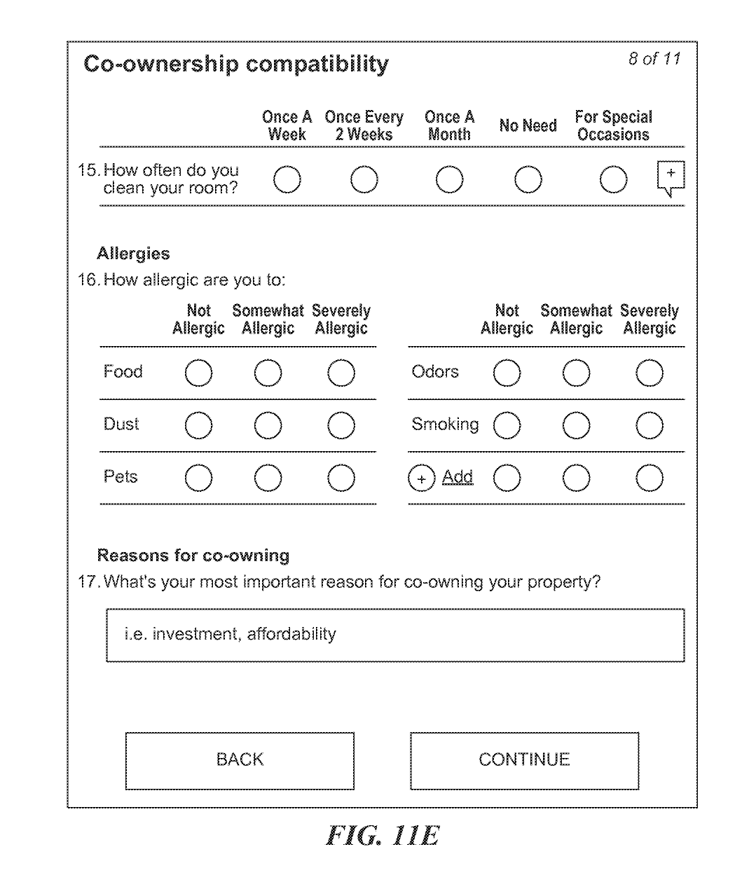

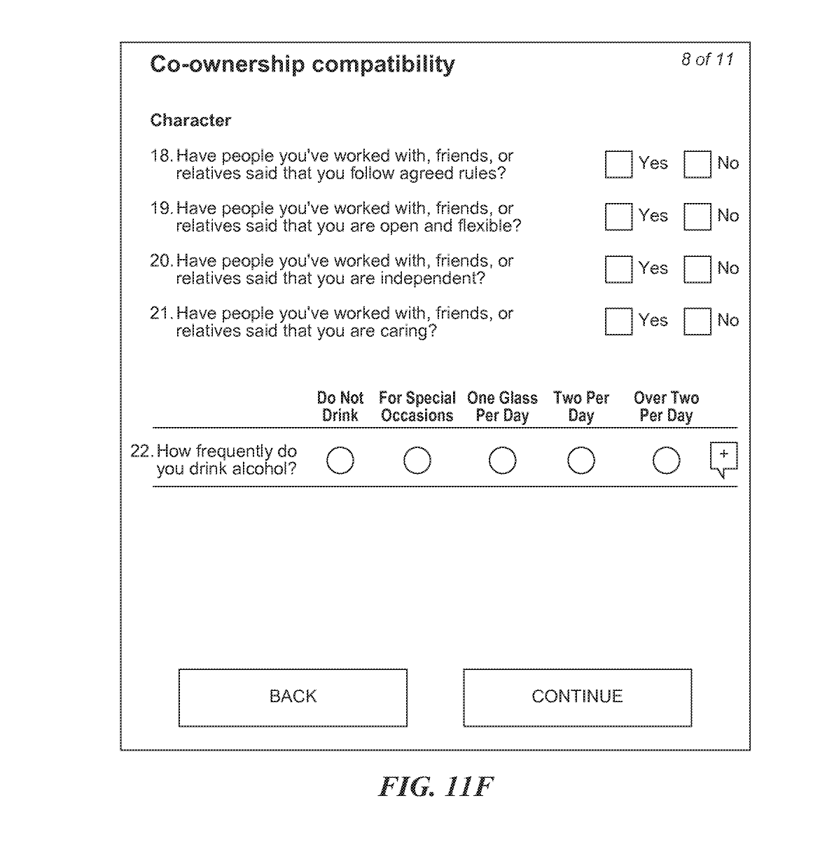

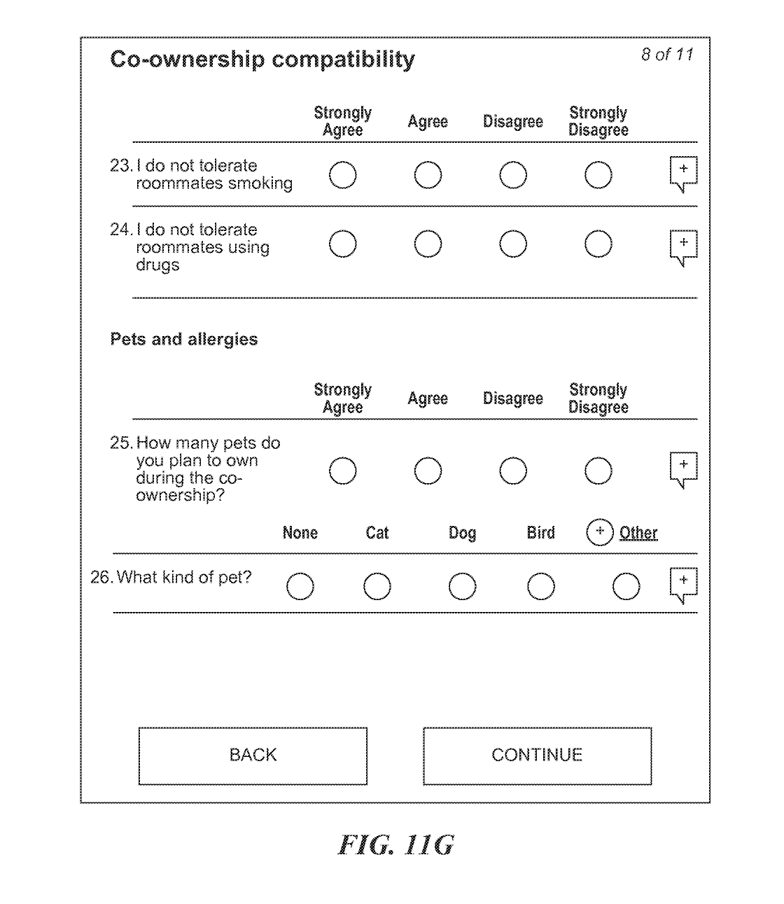

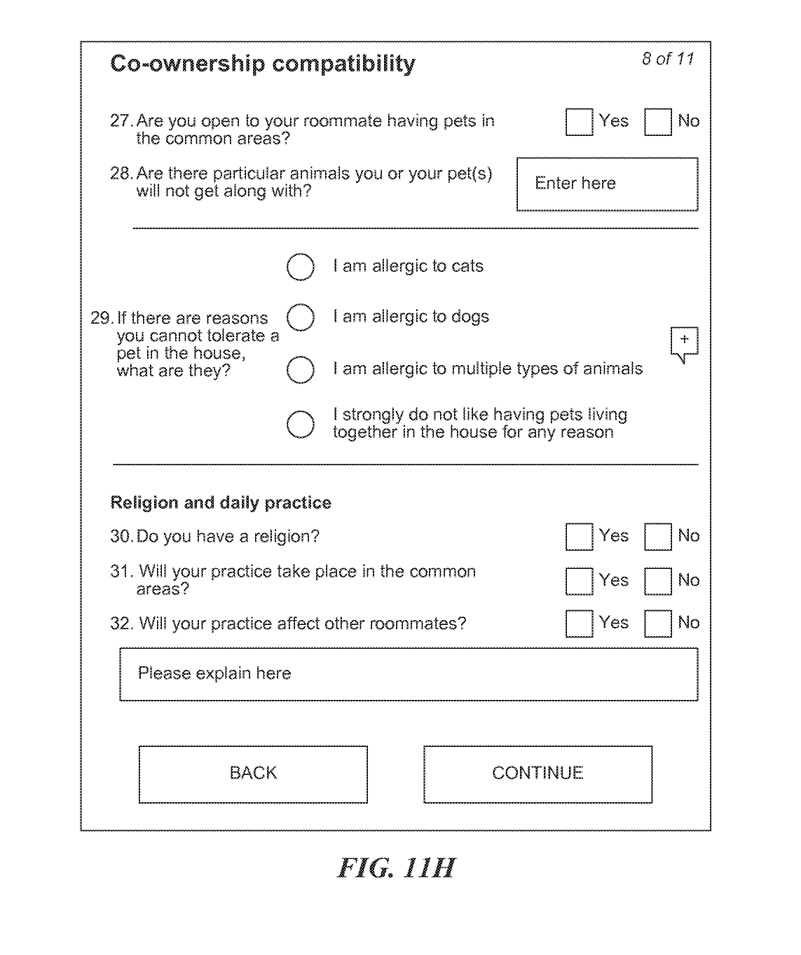

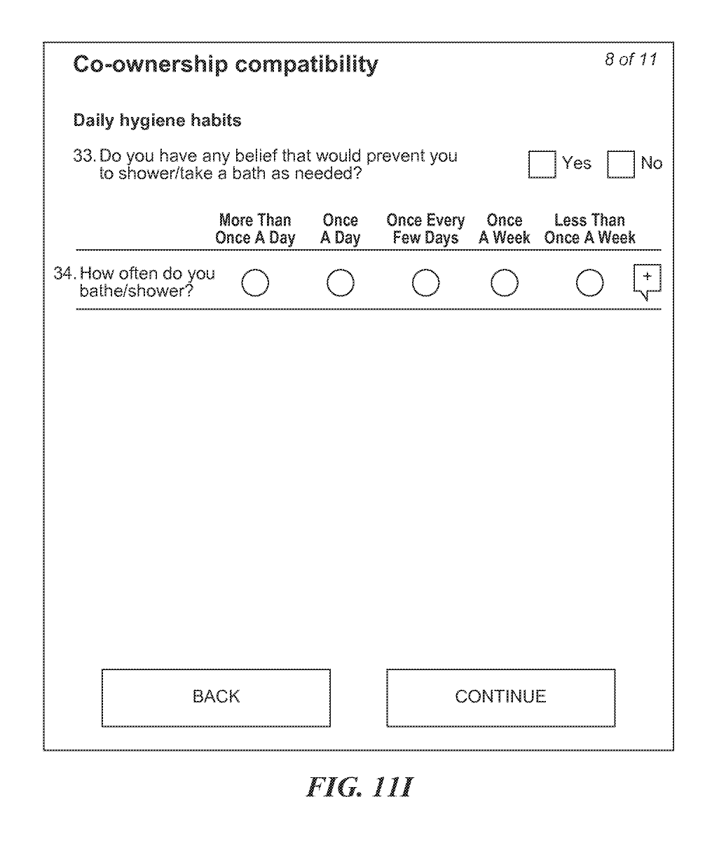

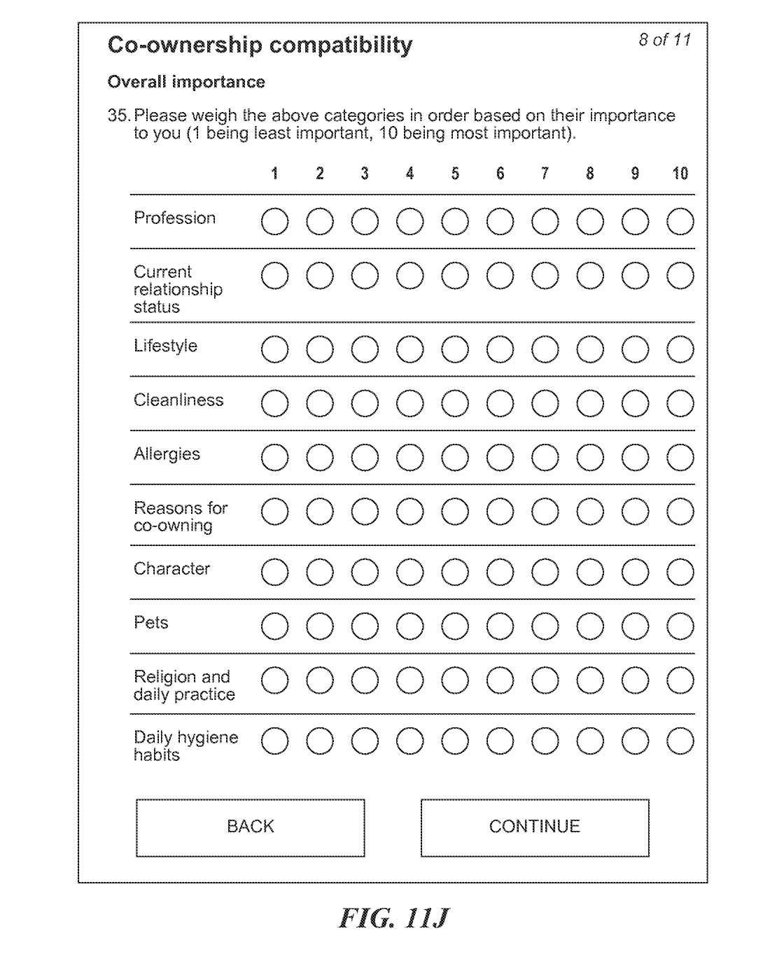

In step 560, responsive to a receipt of the authorization to move to step 560, the server 40 receives, from the first co-owner, answers to a personality questionnaire. The personality questionnaire comprises questions regarding profession, current relationship status, religious practices, or lifestyle. FIGS. 11A-11I are an example of a personality questionnaire that a co-owner fills out, according to one embodiment.

In step 570, the server 40 calculates a match score between the first and the second co-owner based on the answers to the personality questionnaire. According to one embodiment, the server 40 calculates the match score by matching at least a predetermined percentage of questionnaire responses associated with said first co-owner to questionnaire responses associated with the second co-owner. In one embodiment, the predetermined percentage is 50%. According to another embodiment, the server 40 calculates the match score by automatically assigning weights to each questionnaire response, and generating a match score by adding weights of matching questionnaire responses. According to another embodiment, the user assigns weights to each questionnaire response, as shown in FIG. 11J. The server 40 proceeds to step 580 if the match score exceeds a predetermined threshold. In one embodiment, the predetermined threshold is 49% of total weight.

In step 580, the server 40 sends a message to the first co-owner, the message comprising the third privacy tier of information 56, which includes match score, and the questionnaire answers associated with the second co-owner. In step 590, the server 40 receives an input from the first co-owner comprising an instruction to change the answers to the personality questionnaire to affect the score associated with the first co-owner, to delete the second co-owner from the dashboard associated with the first co-owner, or to move to step 595. If the instruction is to change the answers to the personality questionnaire, the server 40 goes to step 560 and repeats the process.

In step 595, responsive to receipt of the instruction to move to step 595, the server 40 generates a set of authorized users comprising said first co-owner and said second co-owner, said set of authorized users configured to send messages to each other, and further said set of authorized users configured to share first, second, and third privacy tier 56 of said information associated with each user. According to one embodiment, the set of authorized users is configured to share all information associated with each other.

### Workflow for Finding a Real Estate Professional

The server 40 asks that the buyer and agent agree to terms of use of the system messaging, such as no sharing of full names, contact info, etc. The system messaging enables the buyer to interview real estate professionals who are users of the system, such as real estate agents, coordinators, or lawyers. The system messaging comprises email, instant messaging, texting, videoconferencing, or any equivalent system messaging.

According to one embodiment, the server 40 suggests a list of real estate professionals to the buyer, who match the criteria associated with the buyer, such as language skills, ZIP code, cost of services associated with the real estate professional etc.

According to one embodiment, based on the outcome of the interview process, the server 40 creates a list of real estate professionals with whom the buyer matches, and the corresponding list of scores, representing the quality of the match between the real estate professional and the buyer.

In one embodiment, if the buyer is a co-owner, the server 40 shares the first co-owner's list with the second co-owner. Once the co-owners agree on a real estate professional to work with, a co-owner selects the real estate professional, such as by clicking a button labeled “final”. In another embodiment, the server 40 automatically determines the real estate professional that is a best match with both of the co-owners.

In one embodiment, real estate professionals who are users of the system, have agreed to pay a percentage referral fee associated with the system. The user professionals agree to the percentage fee during sign-up, and confirm the agreement before using the system messaging for interview with co-owners.

In another embodiment, once the buyer chooses a real estate professional the server 40 sends a message to the buyer and the real estate professional asking them to agree to the referral fee associated with the system.

In another embodiment, the buyer can send a message to real estate professionals associated with an area, that the buyer is looking for real estate property for sale in the area. In another embodiment, the buyer can send messages only to real estate professionals who satisfy buyer specified criteria, such as specified language, or real estate agents in the area who have houses listed for sale.

According to one embodiment, a buyer looking for a real estate professional only sees the first privacy tier of information 52 associated with a real estate professional, and cannot use the system messaging to communicate with the real estate professional. When the buyer adds the real estate professional to the set of authorized users, the server 40 allows the buyer to send messages to the real estate professional, and to view the second privacy tier of information 54 associated with the real estate professional. When the buyer adds the real estate professional to the set of authorized users, the server 40 sends a message to the real estate professional that the buyer has added him to the set of authorized users, and that the buyer can now view second privacy tier of information 54 associated with the real estate professional. The real estate professional can remove himself or herself from the set of authorized users, thus revoking the buyer's authorization to view the second privacy tier 54 associated with a real estate professional, and the buyer's authorization to use the system messaging to communicate with the real estate professional. If the real estate professional does nothing, the real estate professional remains in the set of authorized users. When the buyer settles on the realtor, the server 40 adds the realtor to the set of users authorized to view third privacy tier of information 56 associated with the buyer, and the realtor and the buyer share the third privacy tier of information 56 associated with each other.

### Workflow for Finding a Lender

According to one embodiment, the server 40 suggests to a buyer a list of lenders based on the areas such as where the buyer wants to buy and the areas associated with the lender, the language associated with the lender and the language associated with the buyer, whether the buyer is a co-owner and the lender is a co-owner specialist etc. Using the messaging system, the buyer interviews the lenders in the list of lenders, and the buyer select one lender. Once the lender is selected, the lender can view second privacy tier 54 and third privacy tier 56 associated with the buyer. Buyer and lender work together to get a prequalified letter, which is submitted to the system for verification.

### IV. WORKFLOW FOR SELLERS

### Registration Workflow

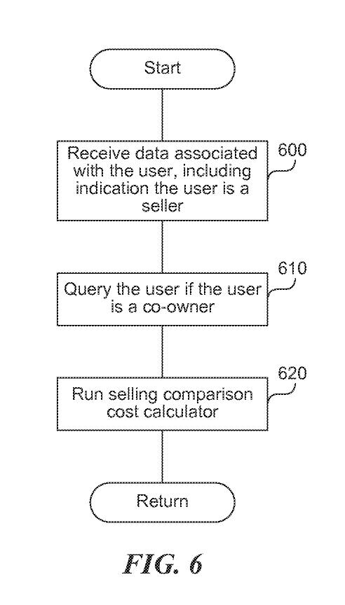

FIG. 6 is a flowchart of registration process associated with a seller, according to one embodiment. In step 600, the server 40 receives data associated with a user, including an indication that the user is a seller. The received data comprises full name, visual representation associated with the seller, phone number, links to social media such as LinkedIn or Facebook, and address of a real estate property for sale. The visual representation can be a picture, a video, a virtual tour, a 3-D computer model, or any visual representation that can be displayed. In step 610, the server 40 queries the seller whether the seller is a co-owner, that is whether the seller is selling just a part of the property. In step 620, the server 40 runs the selling comparison cost calculator.

According to one embodiment, the selling comparison cost calculator queries the user about the sales price of the house, the listing agent fee, the selling agent fee, transaction coordinator price per hour, transaction coordinator cap total hours, coordinator lawyers price per hour, and coordinator lawyer cap total hours. The selling comparison cost calculator outputs potential savings if the seller chooses to not employ a real estate professional, such as the listing agent, the selling agent, the transaction coordinator, or the lawyer.

According to one embodiment, during the registration, the server 40 requires the seller to agree to Terms of Service by accepting the system as a referral system, not as a real estate listing agent. The server 40 asks the seller to agree to pay the system referral fee if a buyer agent is not used by the buyer (i.e. selling direct, with no agent on either side). The server 40 requires the seller to read and agree to disclaimers from the system. The server 40 asks the seller to agree to have the system do some marketing to find referrals, such as a yard sign, Internet exposure, or social media exposure.

### Traditional Workflow

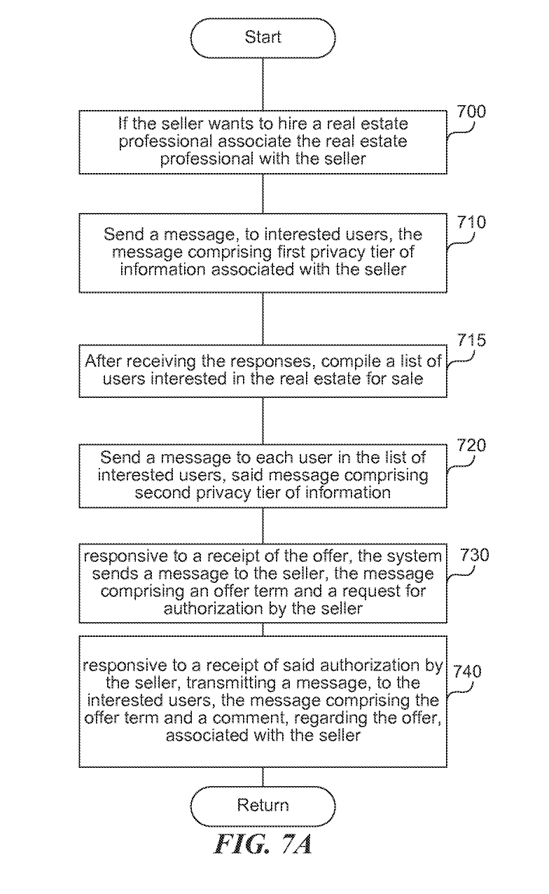

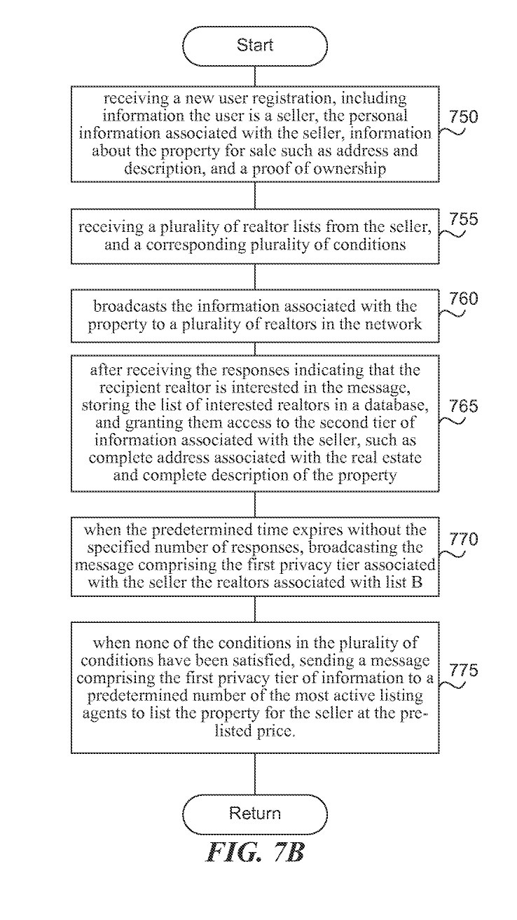

FIG. 7A is a flowchart of the traditional workflow associated with a seller, according to one embodiment. In step 700, if the user wants to hire a real estate professional, such as a listing agent, a coordinator, an escrow company, or a lawyer, the server 40 associates the real estate professional with the user. First, the server 40 queries the user if the user has selected a real estate professional. If the user has selected a real estate professional who is not a user of the system, the server 40 sends a message inviting the real estate professional to register. If the user has not selected a real estate professional, the system messaging enables the seller to interview the real estate professionals who are users of the system. The system messaging comprises email, instant messaging, texting, videoconferencing, or any equivalent messaging system.

According to one embodiment, the server 40 suggests a list of real estate professionals to the seller, who match the criteria associated with the seller, such as language skills, ZIP code, cost of services associated with the real estate professional etc.

Based on the outcome of the interview process, the server 40 creates a list of real estate professionals with whom the seller matches, and the corresponding list of scores, representing the quality of the match between the real estate professional and the seller.

At the end of the interview process, the seller selects a real estate professional by, for example, clicking a “final” button. Responsive to the selection of the real estate professional, the server 40 sends a message to the seller and the real estate professional asking the seller and the real estate professional to agree to the referral fee.

In step 710, the server 40 sends a message to the interested users, such as buyers or buyers' agents, the message comprising first privacy tier of information 52 associated with the seller, and a selector for receiving a user input indicating whether a recipient user is interested in the message. The first privacy tier of information 52 comprises full address associated with a real estate property, sale price, type of the real estate property (e.g. a single home), number of beds, number of baths, number of garages, approximate square footage, lot size, links to public school associated with the real estate property, list of private schools in the vicinity of the real estate property, list of parks in the vicinity, list of restaurants in the vicinity, list of libraries in the vicinity, list of freeways in the vicinity, or a visual representation associated with the real estate property. The visual representation can be a picture, a video, a virtual tour, a 3-D computer model, or any visual representation that can be displayed. In step 715, after receiving the responses indicating that the recipient user is interested in the message, the server 40 compiles a list of users interested in the real estate for sale.

According to one embodiment, buyers' agents who receive the notice from seller either have or have not a buyer at that time. If they do have potential buyer, they reply “yes”, and the potential buyer needs to become a user of the system.

In step 720, for each user in the list of interested users, the server 40 sends a message to each user in the list of interested users, the message comprising second privacy tier of information 54 associated with the seller in the request for an offer. The second privacy tier of information 54 comprises escrow number, escrow company, or open house dates.

In step 730, responsive to a receipt of the offer, the server 40 sends a message to the seller, the message comprising an offer term and a request for authorization by the seller. The message can be an email message within the system, or a cell phone alert. According to one embodiment, the offer term and a request for authorization by the seller comprise second privacy tier of information 54 associated with the seller.

In step 740, after receiving authorization from the seller, the server 40 transmits a message to the interested users, the message including the offer term and a comment, regarding the offer, associated with the seller. The comments include a timeframe to respond to the message, and the seller's opinion of the offer terms. According to one embodiment, the offer term, and the comments regarding the offer comprise second privacy tier of information 54 associated with the seller.

For example, the seller chooses 10 agents with whom to share his house for sale. The seller gets one offer from one of those agents. The asking price is $565K, the offer price is $560K, with a loan of 90% sale price, and closing in 30 days. The seller is motivated but not very happy with the first offer. The seller can choose to fill in a form on the server 40 and disclose the terms of what he gets from the first offer to others: $560K in price, close escrow in 30 days, lender involved with 10% down. The seller can specify where he is not happy with, such as too low a down payment, etc. and how long the other agents have to bring in another buyer who can bid the present offer. This process requires the seller to be honest and have backup copies of offers for lawyer of potential buyers to look at if asked.

After a predetermined amount of time passes, such as a month, the seller is assumed to take the offer the seller got if price is higher than the asking price. If the price the seller got is lower than the asking price, the seller can choose to accept the offer, or lower the asking price, or take the house off the market. This process requires the seller to be honest and have backup copies of offers for lawyer of potential buyers to look at if asked.

The server 40 provides a temporary space for sellers, lawyers, agents to keep contracts or files, or both, for exchange. The server 40 also supports keeping all sensitive documents and shared folders on cloud provider such as Google drive, Dropbox, etc. For record-keeping, the server 40 archives a copy of the final signed contract after successful transaction.

The system users are responsible to move the temporary files to their own computer or own cloud provider such as Google drive, Dropbox as soon as possible. After a warning or two to the users who owns the files, the server 40 will automatically delete the files after a short period of time, such as a few days. The intention is to limit the system's liability for storing important docs, for losing them or for being compromised by hackers.

### Hybrid Workflow

FIG. 7B is a flowchart of the hybrid workflow associated with a seller, according to one embodiment. In step 750, the server 40 receives a new user registration, including information the user is a seller, the personal information associated with the seller, information about the property for sale such as address and description, and a proof of ownership. The server 40 stores this information in a database 50 comprising a plurality of privacy tiers. The first privacy tier of information 52 comprises summary description of the property, such as the price, type of property (e.g. a single home), the square footage, number of beds, number of baths, and can optionally contain just the property ZIP code and not the complete address. The second privacy tier of information 54 associated with the seller includes a complete address associated with the real estate and a complete description of the property. The complete description of the property includes information such as number of garages, lot size list of private schools in the vicinity of the real estate property, list of parks in the vicinity, list of restaurants in the vicinity, list of libraries in the vicinity, list of freeways in the vicinity, or a visual representation associated with the real estate property. The visual representation can be a picture, a video, a virtual tour, a 3-D computer model, or any visual representation that can be displayed.

In step 755, the server 40 receives a plurality of realtor lists from the seller (such as top 100 realtors in a seller specified ZIP Code, city, or county), and a corresponding plurality of conditions (such as the number of days to wait before broadcasting to the next set of realtors and a number of responses before broadcasting to the next set of realtors). For example, a seller can create these lists and corresponding conditions:
1. Create 3 lists of realtors
   a. List A: top 100 realtors in a city
   b. List B: next 200 realtors in the city
   c. List C: all remaining realtors in a county
2. Conditions
   a. broadcast to list A
   b. if 7 days have passed and the seller has received less than 10 responses, broadcasts to list B
   c. if 14 days have passed and the seller has received less than 20 responses, broadcasts to list C.

According to another embodiment, the server 40 selects the plurality of realtors for broadcasting, based on default settings such as the ZIP code associated with the property and a ZIP code associated with the realtors, city or county associated with the property and city or county associated with the realtors. The system can broadcast to a predetermined number of top realtors in a geographical area, such as top 50 realtors in a specified ZIP code, city, or county. The system can also broadcast to all realtors associated with a geographical area, such as ZIP code, city or county.

Once the server 40 verifies the proof of ownership associated with the seller, in step 760, the server 40 broadcasts the information associated with the property to a plurality of realtors in the network. The basic broadcasting algorithm models after the concept of a floodgate, where the flow of data is controlled. The number of realtors receiving the broadcast increases in each successive broadcast. The condition for the next broadcast can be based on time, or number of responses, or both. The system executes the broadcast based on conditions derived from default settings or from seller input.

The information specified in each broadcast message contains the first privacy tier of information 52, and a selector for receiving a user input indicating whether a recipient realtor is interested in the message. The first privacy tier of information 52 comprises summary description of the property and can optionally contain just the property ZIP code and not the complete address.

In step 765, after receiving the responses indicating that the recipient realtor is interested in the message, the server 40 stores the list of interested realtors in a database 50, and grants them access to the second tier of information associated with the seller, such as complete address associated with the real estate and complete description of the property. The interested realtors can then view the second tier of information associated with a seller. Based on the information in the database 50, the system can generate a summary report for the seller to view the results of his broadcast campaign. The information associated with the property for sale can also be submitted to various real estate search websites, such as Zillow or Trulia, so that can be easily searched for consumers.

In step 770, when the predetermined time expires, such as 7 days in the example above, without the specified number of responses, such as 10 responses in the example above, the server 40 can broadcast the message comprising the first privacy tier associated with the seller the realtors associated with list B. According to another embodiment, the server 40 can receive input from the seller extending the time period before the server 40 broadcasts the message to the realtors associated with list B.

In step 775, when none of the conditions in the plurality of conditions have been satisfied, the system sends a message comprising the first privacy tier of information 52 associated with a seller to a predetermined number, such as 3-5, of the most active listing agents to list the property for the seller at the pre-listed price. The server 40 can add those realtors to the set of users authorized to view second privacy tier of information 54 associated with the seller, so that the seller can interview them and have one of them become the seller's listing agent. The system adds the listing agent to the set of users authorized to view third privacy tier of information 56 associated with the seller.

### V. DYNAMICALLY GENERATING A WEBPAGE

After receiving information from each user, the server 40 dynamically generates a webpage comprising information associated with the first privacy tier 52 for each user. The information in the first privacy tier 52 for each user comprises visual representation associated with the user, and other public information. The visual representation can be a picture, a video, a virtual tour, a 3-D computer model, or any visual representation that can be displayed.

According to one embodiment, the generated webpage of a lender shows:
1. Languages spoken
2. First name, last name initial
3. From:
   a. small mortgage co
   b. statewide mortgage co
   c. nationwide mortgage co
   d. small bank
   e. statewide bank
   f. nationwide bank
4. Yelp Rating: stars or none

According to another embodiment, the generated webpage of an attorney shows:
1. Language(s) spoken other than English
2. Specialize in: (can have more than 1 choice)
   a. co-ownership agreements
   b. real estate
   c. Wills, trusts, probate
   d. family/divorce
3. Office/Branch in (city/zip code)
4. First name, last name initial
5. Company
   a. work alone
   b. work for small law firm
   c. work for statewide law firm
   d. work for nationwide law firm
6. Yelp Rating: stars or none
7. Fee:
   a. Fixed, Amount, cap hours
   b. Per hour, capped at amount
   c. Per hour, no cap

According to another embodiment, the generated webpage of a co-owner shows:
1. First name, last name initial.
2. Type (can have more than 1 choice)
   a. buyer roommate
   b. buyer looking for investor for down payment
   c. buyer looking for investor for monthly expenses
   d. seller looking for roommate
   e. seller looking for partial investor
   f. buyer investor looking for other investor(s)
   g. buyer investor looking for resident.
3. Social media: Linked In and/or Facebook verified or not.
4. Want to live in city/zip code (more than 1 is OK).

### VI. SHARE AND TELL TOOL

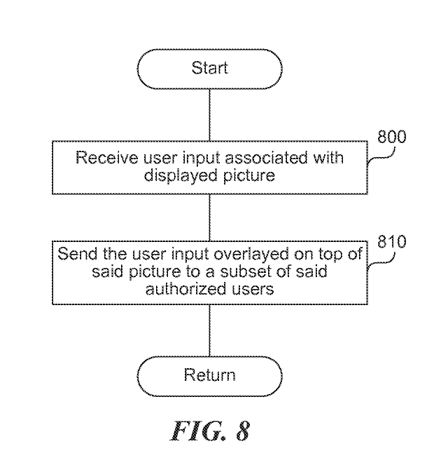

FIG. 8 is a flow chart of a process for sharing and commenting on a real estate visual representation, according to one embodiment. The visual representation can be a picture, a video, a virtual tour, a 3-D computer model, or any visual representation that can be displayed. In step 800, the server 40 receives a user input associated with a displayed real estate visual representation. The user input comprises drawing by said user or comments by said user. The drawing and the comments can be handwritten, or can be generated with the help of a computer. In step 810, the server 40 sends the user inputs and the real estate visual representation to a subset of authorized users, where said subset of authorized users is selected by the user. According to one embodiment, the server 40 saves the visual representation for future use. The visual representation comprises third privacy tier of information 56.

According to one embodiment, a buyer can share with a real estate agent what the buyer likes or does not like in the houses that the buyer has seen on the Internet or during open houses. In another embodiment, co-owners can share with each other what they like or do not like in houses before going to how this together. In another embodiment, a seller can share with other users what the seller thinks is special about the house the seller is offering for sale. In another embodiment, real estate agents can share with the buyer, the real estate that the buyer may be interested in.

FIG. 12B is an example of the information a user can enter to describe the desired property, according to one embodiment.

### VII. IMPLEMENTATION OF USER WITH MULTIPLE ROLES

The server 40 can maintain a plurality of roles associated with a user account, such as a client, or real estate professional. For example, a seller can become a buyer; a real estate professional user can also be a buyer or a seller, or both; a real estate professional user can have multiple professional roles, such as being both a lawyer and an accountant.

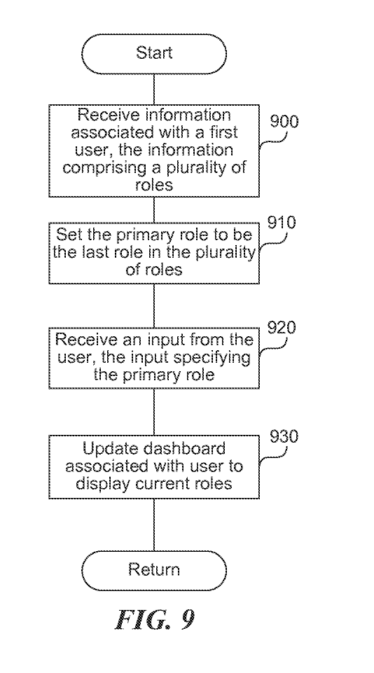

FIG. 9 is a flowchart of a process to determine the primary role and one or more alternate roles, according to one embodiment. In step 900, the server 40 receives information associated with a first user, the information comprising a plurality of roles, such as client or a real estate professional. In step 910, the server 40 sets the primary role to be the last role in the plurality of roles. Optionally, in step 920, the server 40 receives an input from the user, the input specifying the primary role. According to one embodiment, the user selects the primary role from a list of roles. According to another embodiment, the server 40 allows the user to specify a set of rules, such as calendar dates, according to which the server 40 automatically switches primary roles. In step 930, the server 40 updates the dashboard associated with the user to display the current roles associated with a user.

### VIII. REVIEW SYSTEM

The server 40 enables a first user in the transaction to review users, the first user has worked with. When a transaction is complete or is canceled, the server 40 sends a form to the users involved in the transaction, the form comprising a first box in which to write comments, multiple questions, and the second box in which to write comments. The server 40 receives from the first user a review regarding a second user, the review comprising two privacy tiers of reviews. The first privacy tier 52 is configured to authorize access to all users. The second privacy tier 54 is configured to limit access to the server 40. The first privacy tier 52 includes the comments in the first box and the answers to the multiple questions. The second privacy tier 54 includes the comments in the second box. The server 40 stores the comments in the second box for analysis by the server 40.

In one embodiment, multiple questions comprise feedback on the buyer or seller, who was part of the transaction:
1. cooperative: 1 star to 5 stars
2. communication: 1 star to 5 stars
3. follow instructions: 1 star to 5 stars
4. would you work with this buyer/seller again? (Y/N).

In another embodiment, multiple questions comprise feedback on the attorney who was part of the transaction:
1. responsiveness: 1 star to 5 stars
2. communication: 1 star to 5 stars
3. competitive fee: 1 star to 5 stars
4. professional: 1 star to 5 stars
5. would you work with this attorney again? (Y/N).

### IX. SAFE LOCKS

The server 40 can control electronic door locks associated with a real estate property. The electronic door locks unlock if the correct entry code is entered. The server 40 receives an input from an owner of a real estate property, the input comprising the correct entry code. The server 40 creates the entry code associated with a the electronic lock. The server 40 receives from the owner the specification of an event that invalidates the entry code, such as the number of times the entry code was used, or after a period of time. If the server 40 does not receive the invalidating event, the server 40 keeps the code active until the server 40 receives an instruction to delete the code.

According to one embodiment, a camera at the real estate property can record when there is movement at the door. According to another embodiment, the camera records when a code is entered at the door. In another embodiment, the camera records only when a user specified code is entered at the door.

The server 40 logs the time of entry, the entry code, and if a video exist, the video associated with the entry. The server 40 stores the log during a period of time, or until the log is deleted by the owner. According to one embodiment, the server 40 sends a warning to the owner if an incorrect entry code is entered more than a predetermined number of times, such as more than three times. According to one embodiment, the server 40 automatically lights up the lock if a light intensity falls below a default threshold. In one embodiment, the server 40 automatically warns the owner when the battery is low and needs to be replaced. In another embodiment, the electronic lock is enabled to scan the IDs or documents associated with the user entering the code, to match the scanned identification with the identification on file, and to refuse entry if the scanned identification and the identification on file to not match.

### X. NATIONAL REAL ESTATE RATING SYSTEM

Currently, there is no national real estate rating system because data is kept within brokers of franchises of national companies. However, the system, disclosed here, collects data regarding the transactions for each city, and each ZIP code. The database 50 stores the reviews associated with the real estate professionals, the number of transactions associated with a real estate professional within a predetermined period of time (such as within 6 months), geographic location of the transaction, such as city and ZIP code, dollar amount of the transaction etc.

According to one embodiment, the data regarding the transactions can be provided by a real estate professional involved with the transaction. If the real estate professional disputes the number of transactions associated with the professional, the professional can show authorized documents as a proof of transactions that the server 40 did not record. According to one embodiment, the server 40 automatically verifies the veracity and content of the documents and updates the number of transactions in the database 50.

According to another embodiment, the server 40 automatically gathers the data associated with a real estate professional user, the data including a number of completed real estate transactions, and a ZIP code associated with the real estate transaction. The transactions can take place within the system, or can be logged in a real estate database, such as MLS. The server 40 generates a list ranking a plurality of real estate professional users, based on the number of completed real estate transactions within a ZIP code.

The server 40 periodically sends a message to the users, the message comprising a list of any number of top real estate professional within each geographic zone, such as city, or ZIP code. The list comprising the real estate professional name, and the number of transactions associated with the real estate professional. The email also asks the real estate professional to correct any erroneous information associated with a professional. According to one embodiment, the server 40 receives an input from the real estate professional regarding the geographic zone associated with a real estate professional.

According to one embodiment, the server 40 can include in the dynamically generated webpage associated with a real estate professional, information regarding the ranking associated with the real estate professional, if the real estate professional is among the top real estate professionals. According to another embodiment, the server 40 can include in the dynamically generated webpage the ranking associated with the real estate professional, regardless of the ranking.

### XI. THE SYSTEM REVENUE MODEL

The system revenues come from referral fees from:
1. Traditional model: the system collects referral fees from either listing or buyer agent.
2. Hybrid model: the system collects referral fees from buyer's agent and seller: cost to seller is 3% to 3.5% of sales price. The system fee is 0.5% of sales+30% of broker commission.
3. Direct Sales by the system users: the system collects referral fees from seller.

The system makes most revenue in the following order:
1. Direct seller to buyer found in the system network.
2. The system hybrid model.
3. Traditional model with buyer agent.
4. Traditional model with listing agent.

The higher the sales price, the more the system makes in all following models
1. Direct selling: 2.5% of sales price
2. The system hybrid model: 30% of buyer broker commission
3. Traditional model with buyer agent: 30% of buyer broker commission
4. Traditional model with listing agent: 30% of listing broker commission.

The seller saves cost for being a user of the system network, in addition to having more options than before. The buyer can still get closing costs refunds from their broker as before.

According to one embodiment, in the direct selling model, the system refunds part or all closing costs to promote the direct selling model and to get more buyers in the network.

In both the direct selling and hybrid models, the risk of fraud from seller to not pay fee to the system is high. The system requires the seller to sign a written agreement like traditional listing agreement upfront where fees are guaranteed to be paid if house sold using the resources associated with the system.

The system calculator receives input from the seller such as price of the house, percentage to be paid to the listing agent, percentage to be paid to the buyer's agent, and outputs the net gain associated with the seller in the three different scenarios: traditional, hybrid, and direct.

### XII. COMPUTER SYSTEM

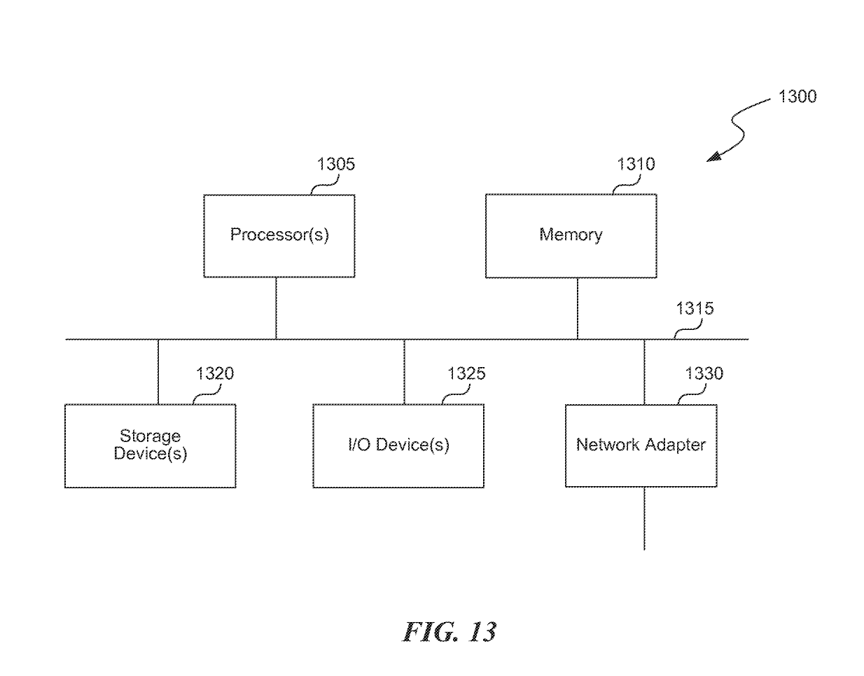

FIG. 13 is a block diagram of a computer system as may be used to implement certain features of some of the embodiments. The computer system may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions (sequential or otherwise) that specify actions to be taken by that machine.

The computing system 1300 may include one or more central processing units (“processors”) 1305, memory 1310, input/output devices 1325 (e.g., keyboard and pointing devices, touch devices, display devices), storage devices 1320 (e.g., disk drives), and network adapters 1330 (e.g., network interfaces) that are connected to an interconnect 1315. The interconnect 1315 is illustrated as an abstraction that represents any one or more separate physical buses, point to point connections, or both connected by appropriate bridges, adapters, or controllers. The interconnect 1315, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called “Firewire”.

The memory 1310 and storage devices 1320 arc computer-readable storage media that may store instructions that implement at least portions of the various embodiments. In addition, the data structures and message structures may be stored or transmitted via a data transmission medium, e.g., a signal on a communications link. Various communications links may be used, e.g., the Internet, a local area network, a wide area network, or a point-to-point dial-up connection. Thus, computer readable media can include computer-readable storage media (e.g., “non-transitory, media) and computer-readable transmission media.

The instructions stored in memory 1310 can be implemented as software and/or firmware to program the processor(s) 1305 to carry out actions described above. In some embodiments, such software or firmware may be initially provided to the processing system 1300 by downloading it from a remote system through the computing system 1300 (e.g., via network adapter 1330).

The various embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### XIII. REMARKS

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

The techniques introduced here can be implemented by, for example, programmable circuitry, e.g. one or more processors, programmed with software and/or firmware, entirely in special-purpose hardwired, i.e. non-programmable, circuitry, or in a combination of such forms. Special-purpose circuitry may be in the form of, for example, one or more application-specific integrated circuits (ASICs), programmable logic devices (PLDs), field-programmable gate arrays (FPGAs), etc.

The printing systems, methods, and ink formulations described herein could also be used to print onto surfaces that have features and indentations that normally would prevent accurate sublimation, e.g. curves. In such instances, an image could be printed onto a flexible former material that is pressed onto the surface of the substrate. When heated, the dye is able to diffuse from the former material into the substrate.

The language used in the Detailed Description has been principally selected for readability and instructional purposes, and it may not have been selected to delineate or circumscribe the inventive subject matter. It is therefore intended that the scope of the technology be limited not by the Detailed Description, but rather by any claims that issue on an application based hereon. Accordingly, the disclosure of various embodiments is intended to be illustrative, but not limiting, of the scope of the embodiments, which is set forth in the following claims.

1. A method for maintaining privacy in a machine directed workflow, comprising:
receiving, by a processor, from a first device associated with a first user, information associated with said first user, said information comprising questionnaire responses associated with said first user;
storing, by a processor, said information associated with said first user in a database, wherein said information comprises a plurality of privacy tiers, wherein a first privacy tier is configured to authorize access to all users, and wherein a second privacy tier and a third privacy tier are configured to limit access to a subset of users;
receiving, by a processor, from a second device associated with a second user, information associated with said second user, said information comprising questionnaire responses associated with said second user;
storing, by a processor, said information associated with said second user in a database, wherein said information comprises a plurality of privacy tiers, wherein a first privacy tier is configured to authorize access to all users, and wherein a second privacy tier and a third privacy tier are configured to limit access to a subset of users;
calculating, by a processor, a match score between said first user and said second user, by comparing said questionnaire responses associated with said first user with questionnaire responses associated with said second user;
storing, by a processor said match score in said second privacy tier associated with said database;
when said match score between said first user and said second user is above a predetermined threshold, dynamically generating, by a processor, for display at said first device, a webpage comprising said first privacy tier of information associated with said second user;
responsive to a receipt of a selection of said webpage by said first user, transmitting a message, by a processor, to said second device, said message comprising said second privacy tier of information associated with said first user, and a request for an authorization by said second user;
responsive to a receipt of said authorization by said second user, transmitting a message, by a processor, to said first device associated with said first user, said message comprising said third privacy tier of information associated with said second user, and a request for an authorization by said first user; and
responsive to a receipt of said authorization by said first user, generating, by a processor, a set of authorized users comprising said first user and said second user, said set of authorized users configured to send messages to each other, and further said set of authorized users configured to share first, second, and third privacy tier of information associated with each other.

2. The method of claim 1, wherein said first privacy tier of information comprises a visual representation associated with said first user, a first name associated with said first user, when said user is a buyer, a dollar amount of a loan for which said buyer is prequalified, and when said user is a buyer making a purchase for cash a proof of funds.

3. The method of claim 1, wherein said second privacy tier of information comprises attributes associated with a desired property, said attributes comprising: a city, a state, a ZIP code, a number of bedrooms, a number of bathrooms, a type of property, a price range, and a visual representation of a property in which said user is interested.

4. The method of claim 1, wherein, said third privacy tier of information comprises questionnaire answers associated with said first user.

5. The method of claim 1, further comprising:
receiving, by a processor, a user input associated with a visual representation of a real estate, said user input comprising drawing by said user and comments by said user; and
sending, by a processor, said user input and said real estate visual representation to a subset of said set of authorized users, wherein said subset of said authorized users is selected by said user; and
storing, by a processor, said user input and said real estate visual representation into said database, said user input and said real estate visual representation comprising third privacy tier of information.

6. The method of claim 1, wherein dynamically generating said webpage comprises:
obtaining, by a processor, a visual representation associated with said second user and said first privacy tier of information associated with said second user; and
creating, by a processor, a layout comprising said visual representation and said first privacy tier of information.

7. The method of claim 1, wherein said information associated with said first user is received in a language specified by said first user, and wherein said webpage is dynamically generated in said language specified by said first user.

8. The method of claim 1, further comprising:
receiving, by a processor, from said first device, an indication of a list of languages; and
dynamically generating, by a processor, a version of said webpage corresponding to each language in said list of languages.

9. The method of claim 1, wherein calculating, by said processor, said match score comprises:
receiving, by a processor, from said first device, a weight associated with each questionnaire response; and
generating, by a processor, a match score by adding said weight associated with a matching questionnaire response.

10. A system for maintaining privacy in a machine directed workflow, comprising:
a processor; and
a storage medium storing computer-executable instructions that, when executed by said processor, cause said system to perform a computer-implemented operation, said instructions comprising:
instructions for receiving, by a processor, from a first device associated with a first user, information associated with said first user, said information comprising questionnaire responses associated with said first user;
instructions for storing, by a processor, said information associated with said first user in a database, wherein said information comprises a plurality of privacy tiers, wherein a first privacy tier is configured to authorize access to all users, and wherein a second privacy tier is configured to limit access to a subset of users;
instructions for broadcasting, by a processor, a message to a plurality of user devices associated with a plurality of users, said message comprising said first privacy tier of information associated with said first user and a selector for receiving a user input indicating whether a recipient user is interested in said message, said first privacy tier of information comprising a sale price associated with a real estate property;
responsive to a receipt of a selection indicating that said recipient user is interested in said message, instructions for transmitting a message, by a processor, to a recipient user device associated with said recipient user, said message comprising said second privacy tier of information associated with said first user, and a request for an offer;
responsive to a receipt of said offer, instructions for sending a message to said first user device, said message comprising an offer term associated with a buyer and a request for authorization by said first user; and
responsive to a receipt of said authorization by said first user, instructions for transmitting a message, by a processor, to a plurality of devices associated with a plurality of buyers, said message comprising said offer term and a comment, regarding said offer, associated with said first user.

11. The system of claim 10, wherein said second privacy tier of information comprises escrow number associated with said real estate property, escrow company associated with said real estate property, and open house dates associated with said real estate property.

12. The system of claim 10, wherein instructions for broadcasting said message comprises:
instructions for receiving, by a processor, from said first device associated with said first user a plurality of realtor lists and a corresponding plurality of conditions; and
when a condition in said plurality of conditions is satisfied, instructions for broadcasting, by a processor, said message comprising said first privacy tier of information, to a corresponding realtor list in said plurality of realtor lists.

13. The system of claim 10, further comprising:
instructions for receiving, by a processor, from said first device a review regarding a second user, said review comprising two privacy tiers of reviews, wherein said first privacy tier is configured to authorize access to all users, and wherein second privacy tier is configured to limit access to said processor.

14. The system of claim 10, wherein said information associated with said first user comprises a plurality of roles comprising a client, and a real estate professional.

15. The system of claim 10, further comprising:
instructions for gathering, by a processor, a data associated with a user, who is a real estate professional, said data comprising a number of completed real estate transactions and a ZIP code associated with said real estate transactions; and
instructions for generating a list ranking a plurality of real estate professional users, based on said number of completed real estate transactions within a ZIP code.
